(19) United States
(12) Patent Application Publication
(10) Pub. No.: US 2008/0190719 A1
(43) Pub. Date: Aug. 14, 2008

(54) VARIABLE DAMPING FORCE VALVE OF SHOCK ABSORBER

(75) Inventor: Young Hwan Jee, Yeoju-eup (KR)

Correspondence Address: SEED INTELLECTUAL PROPERTY LAW GROUP PLLC, 701 FIFTH AVE, SUITE 5400, SEATTLE, WA, 98104, US

(73) Assignee: MANDO CORPORATION, Seoul (KR)

(21) Appl. No.: 12/025,435

(22) Filed: Feb. 4, 2008

(30) Foreign Application Priority Data
Feb. 8, 2007 (KR) 10-2007-0013165

(51) Int. Cl. F16F 9/34; F16K 31/02

(52) U.S. Cl. 188/322.13; 251/129.15

(57) ABSTRACT

A variable damping force valve of a shock absorber includes a variable valve for varying damping force by a plurality of flow passages connected to the shock absorber and a solenoid actuator for actuating the variable valve. The variable valve and the solenoid actuator are coupled with each other by a coupling ring in a single body, and the coupling ring has an open portion, thereby being coupled to an inside of the variable valve by elastic deformation or restitution thereof to fix the solenoid actuator and the variable valve. Accordingly, there is an advantage in that the variable valve and the solenoid actuator are assembled in one-touch manner by providing the coupling ring, thereby simplifying an assembling process.

### BACKGROUND

1. Technical Field

The present invention relates to a variable damping force valve of a shock absorber, and more particularly, to a variable damping force valve of a shock absorber, in which a variable valve for adjusting a damping force and an actuator for actuating the variable valve are assembled.

2. Description of the Related Art

As a vehicle becomes popularized, a level of the customer's knowledge and requirement for the vehicle gets higher, and functional performances such as output power, silence, ride comfort, handling stability and the like as well as purpose, convenience and economical efficiency of the vehicle become important selection criterions of customers who will purchase a vehicle.

A vehicle is continuously subjected to vibration or shock transmitted from the road through road wheels during driving of the vehicle. Thus, a shock absorbing device is provided between a vehicle body (or a frame) and an axle (or a wheel shaft) to prevent vibration or shock from being transmitted directly to the vehicle body, thereby improving ride comfort of the vehicle. In addition, driving stability of the vehicle is improved by suppressing irregular vibration of the vehicle body. A suspension means a coupling device, including the aforementioned shock absorbing device, between a vehicle body and an axle. In general, the suspension comprises various components, such as chassis springs, shock absorbers for suppressing free vibration of the chassis spring to enhance ride comfort, a stabilizer for adjusting a vehicle height, a rubber bushing, a control arm and the like.

In particular, a shock absorber is mounted between a vehicle body and a road wheel in order to serve to suppress and damp the vibration transmitted from the road. The shock absorber absorbs vertical vibration energy of the vehicle body to enhance ride comfort, protect vehicle freight, and reduce dynamic stress of each part of the vehicle body, thereby increasing durability/lifespan of the vehicle. In addition, the shock absorber suppresses movement of an unsprung mass to secure ground contact performance of a tire.

In the meantime, in order to enhance ride comfort or handling stability of the vehicle according to a road condition and driving state, a damping force variable shock absorber capable of appropriately adjusting a damping force characteristic has been developed. In general, the damping force variable shock absorber mainly controls a change of damping force by the operation of a variable valve, which operates in a solenoid operating manner.

Such a variable valve is configured to increases or decreases rebound and compression damping force of the shock absorber depending on a solenoid current.

Specifically, in a variable damping force valve, a variable valve having a spool is inserted into a housing, and a solenoid actuator for controlling operation of the variable valve is provided at one side thereof. The damping force control is achieved in such a manner that a spool moving according to operation of a solenoid actuator controls the generation and adjustment of back pressure in a back pressure chamber (or a pilot chamber) formed in the rear of a disc valve for varying the damping force.

However, in such a conventional variable damping force valve of a shock absorber, a front end of the variable valve and the solenoid actuator are coupled with each other in a screw coupling manner. Accordingly, the conventional variable damping force valve is disadvantageous in that many processes for machining thread portion on the elements and coupling the variable valve and the solenoid actuator should be performed and thus the productivity lowers due to an increase of the manufacturing processes.

### BRIEF SUMMARY

An object of the present invention is to provide a variable damping force valve of a shock absorber wherein a process for assembling the solenoid actuator is simplified to thereby increase the productivity.

According to an aspect of the present invention for achieving the objects, there is provided a variable damping force valve of a shock absorber including a variable valve connected to a shock absorber to vary damping force and a solenoid actuator for actuating the variable valve. The variable valve and the solenoid actuator are coupled with each other by a coupling ring in a single body, and the coupling ring has an open portion, thereby being coupled to an inside of the variable valve by elastic deformation or restitution thereof to fix the solenoid actuator and the variable valve.

The variable valve may have a catching groove formed on an inner surface thereof, and the coupling ring may have a catching protrusion formed on an outer surface thereof and corresponding to the catching groove. In addition, the coupling ring may have an inclined surface formed on a portion which is in contact with the solenoid actuator. Furthermore, the coupling ring may have a pushing protrusion formed at an end opposite to the portion at which the catching protrusion is formed, wherein the pushing protrusion protrudes outward to press the coupling ring inward.

### BRIEF DESCRIPTION OF THE SEVERAL VIEWS OF THE DRAWINGS

FIG. 1 is a view showing a shock absorber to which a variable damping force valve according to the present invention is applied;

FIG. 2 is a view schematically showing the variable damping force valve of a shock absorber according to the present invention;

FIGS. 3a to 3c are views showing a process in which the variable damping force valve of a shock absorber according to the present invention is assembled; and

FIG. 4 is a plan view of a coupling ring of the variable damping force valve of a shock absorber according to the present invention.

### DETAILED DESCRIPTION

Hereinafter, an embodiment of a variable damping force valve of a shock absorber according to the invention will be described in more detail with reference to the accompanying drawings.

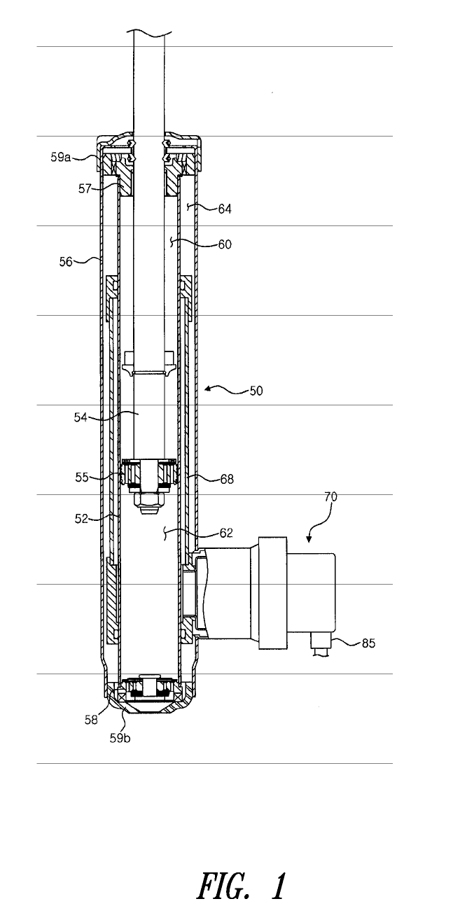

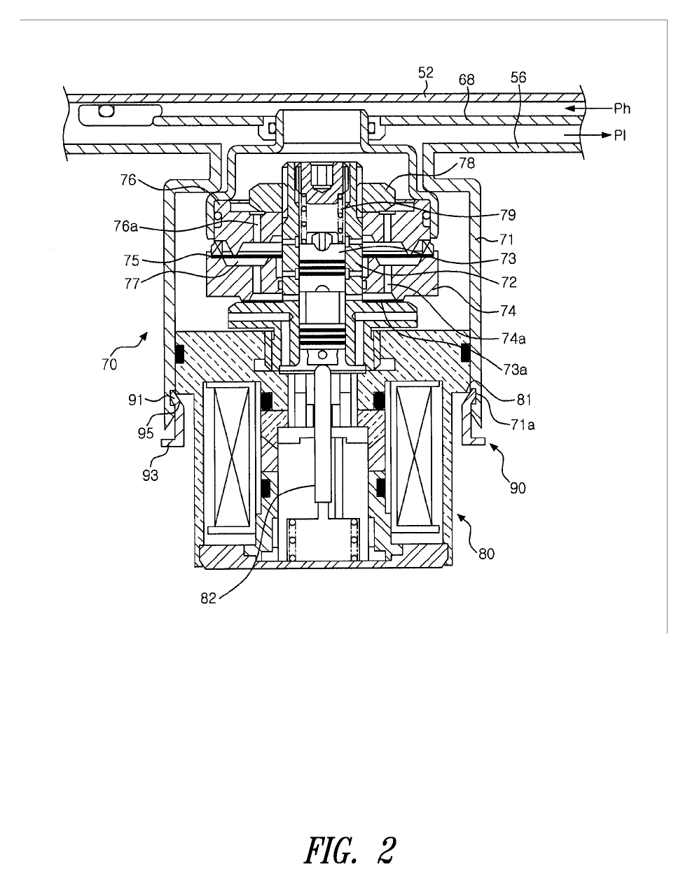

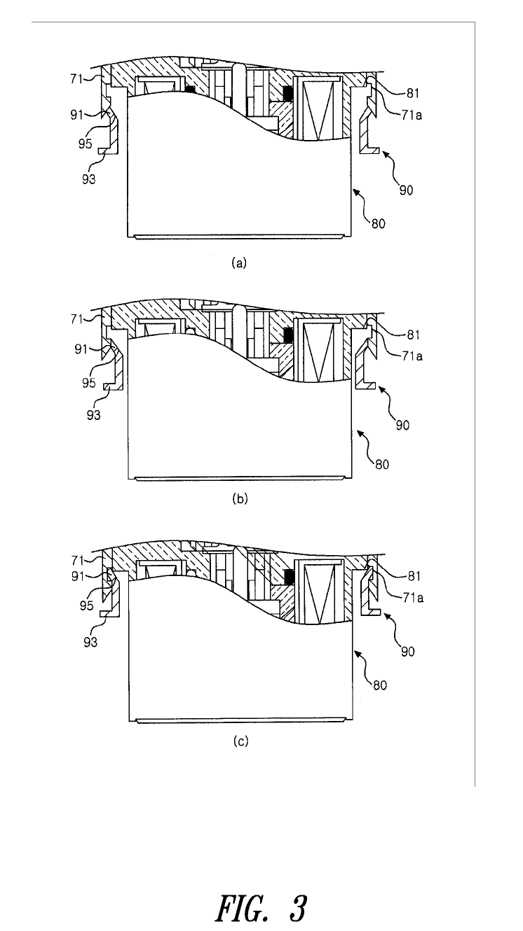

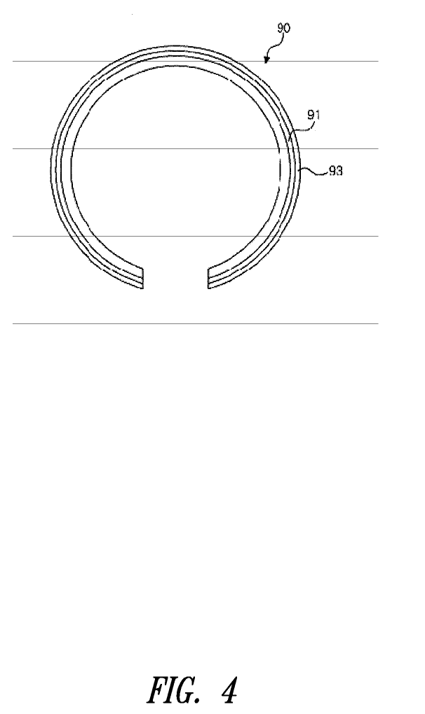

FIG. 1 is a view showing a shock absorber to which a variable damping force valve according to the present invention is applied, FIG. 2 is a view schematically showing the variable damping force valve of a shock absorber according to the present invention, and FIGS. 3a to 3c are views showing a process in which the variable damping force valve of a shock absorber according to the present invention is assembled. FIG. 4 is a plan view of a coupling ring of the variable damping force valve of a shock absorber according to the present invention.

As shown in FIG. 1, a shock absorber 50 according to one embodiment comprises a cylinder 52 having a predetermined length and diameter and having a lower end connected to an axle, and a piston rod 54 installed to reciprocate and having an end inserted into a side of the cylinder 52 and the other end protruding out of the cylinder 52.

The cylinder 52 is filled with working fluid, such as gas, oil or the like, and a base shell 56 is disposed at an outside of the cylinder. A rod guide 57 is provided at an upper end of the cylinder and base shell 52 and 56, while a body valve 58 is installed at a lower end of the cylinder and base shell. In addition, the cylinder 52 is provided with a piston valve 55, which is coupled with an end of the piston rod 54 to divide an inner space of the cylinder into a rebound chamber 60 and a compression chamber 62. In addition, an upper cap 59a and a base cap 59b are provided at upper and lower portions of the base shell 56, respectively.

A reservoir chamber 64 is provided between the cylinder 52 and the base shell 56 to compensate a change of inner volume of the cylinder 52 due to the reciprocation of the piston rod 54. The flow of working fluid between the reservoir chamber 64 and the compression chamber 62 is controlled by the body valve 58.

In the meantime, a variable valve 70 for varying a damping force is installed at one side of the base shell 56 of the shock absorber 50. In addition, a solenoid actuator 80 (FIG. 2) which is operated by electric power supplied through an electric cable 85 is coupled with the variable valve 70.

Further, an intermediate tube 68 connected to the rebound chamber 60 of the cylinder 52 is provided between the cylinder 52 and the base shell 56, so that a high pressure side Ph (FIG. 2) connected to the rebound chamber 60 of the cylinder 52 and a low pressure side Pl (FIG. 2) connected to the reservoir chamber 64 are defined.

As shown in FIG. 2, the variable damping force valve installed at one side of the shock absorber 50 includes the variable valve 70, the solenoid actuator 80 connected to the variable valve 70, and a coupling ring 90 for fixedly connecting them.

A housing 71 of the variable valve 70 is provided with a spool rod 72, which is formed with a plurality of flow passages in fluid communication with an upper portion of the solenoid actuator 80. The spool rod 72 is provided with a spool 73, which is actuated by the solenoid actuator 80 and opens/closes the flow passages. To this end, a pressurizing rod 82 which is operated by a solenoid is provided in the solenoid actuator 80 in order to actuate the spool 73.

A first ring disc 73a functioning as a fixing orifice is installed in the spool rod 72, and a lower retainer 74 including a connecting port 74a allowing fluid to flow is installed at an upper portion of the first ring disc 73a.

A second ring disc 75 functioning as a main valve is installed to an upper portion of the lower retainer 74. The second ring disc 75 separates a pilot chamber 77 formed at the upper portion of the lower retainer 74 from the high pressure side Ph. In addition, an upper retainer 76 including a connecting port 76a allowing fluid to flow is installed at the upper portion of the second ring disc 75.

A nut 78 is coupled with the spool rod 72 to couple the lower retainer 74 and the upper retainer 76 with each other. In the meantime, a spring 79 is interposed between an end of the spool rod 72 and the spool 73 to bring the spool 73 into contact with the solenoid actuator 80.

The coupling of the solenoid actuator 80 and the variable valve 70 is achieved by a catching groove 71a formed on an inner surface of the housing 71 of the variable valve 70 and the coupling ring 90 having a catching protrusion 91 caught to the catching groove 71a.

In addition, the solenoid actuator 80 is formed with a step 81 such that an outer diameter of a side of the step connected to the variable valve 70 is substantially the same as an inner diameter of the housing 71 and an outer diameter of another side of the step is smaller than an inner diameter of the housing 71.

As shown in FIGS. 3 and 4, the coupling ring 90 has a ring shape having an open portion and is made of an elastic material. It is preferable that a pushing protrusion 93 protruding toward the outside is formed on the outer surface of the coupling ring 90 to thereby apply pressure inward.

In other word, the coupling ring 90 is provided such that the catching protrusion 91 is caught to the catching groove 71a formed on the inner surface of the housing 71 of the variable valve 70. Since the coupling ring 90 is made of an elastic material, the coupling ring 90 pressurizes the pushing protrusion 93 inward, so that the coupling ring 90 can be detachably installed to the housing 71 of the variable valve 70.

Further, a portion of the coupling ring 90, which is in contact with an edge of the step 81 of the solenoid actuator 80, is formed into an inclined surface 95, thereby guiding the catching protrusion 91 of the coupling ring 90 to be inserted into the catching groove 71a of the housing 71. In addition, the edge of the step 81 of the solenoid actuator 80 catches the inclined surface 95 thereby, preventing the solenoid actuator 80 from escaping from the variable valve 70.

According to embodiments of the present invention, a variable damping force valve of a shock absorber is advantageous in that a variable valve and a solenoid actuator are assembled in one-touch manner by providing a coupling ring to thereby simplifying an assembling process.

In addition, there is an advantage in that the simplified assembling process causes the productivity to increase.

The above descriptions are merely exemplary embodiments for implementing the present invention, so that the present invention is not limited thereto. The true scope of the present invention should be defined to the extent that those skilled in the art can make various modifications and changes thereto without departing from the scope of the invention, as defined by the appended claims.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A variable damping force valve of a shock absorber comprising:
a variable valve configured to couple to the shock absorber to vary damping force;
a solenoid actuator for actuating the variable valve; and
a coupling ring coupling the variable valve to the solenoid actuator in a single body, the coupling ring having an open portion, thereby being coupled to an inside of the variable valve by elastic deformation or restitution thereof to fix the solenoid actuator and the variable valve.

2. The variable damping force valve as claimed in claim 1 wherein the variable valve includes a catching groove formed on an inner surface thereof, and the coupling ring includes a catching protrusion formed on an outer surface thereof and corresponding to the catching groove.

3. The variable damping force valve as claimed in claim 1 wherein the coupling ring includes an inclined surface formed on a portion thereof which is in contact with the solenoid actuator.

4. The variable damping force valve as claimed in claim 2 wherein the coupling ring includes a pushing protrusion formed toward an end of the coupling ring opposite to an end of the coupling ring toward which the catching protrusion is formed, the pushing protrusion protruding outward to press the coupling ring inward.
